(19) United States
(12) Patent Application Publication
(10) Pub. No.: US 2025/0368337 A1
(43) Pub. Date: Dec. 4, 2025

(54) EVACUATION SLIDE/RAFT DAISY CHAIN RELEASE MECHANISM

(71) Applicant: GOODRICH CORPORATION, Charlotte, NC (US)

(72) Inventor: Craig Erwin Prevost, Surprise, AZ (US)

(73) Assignee: GOODRICH CORPORATION, Charlotte, NC (US)

(21) Appl. No.: 18/732,921

(22) Filed: Jun. 4, 2024

(51) Int. Cl. B64D 25/14

(52) U.S. Cl. CPC B64D 25/14

(57) ABSTRACT

An emergency evacuation slide/raft for an aircraft is disclosed herein. The emergency evacuation slide/raft includes a girt, a daisy chain assembly, a release mechanism, a release pin, and a pull handle. The daisy chain assembly is configured to couple the girt to a girt sleeve affixed to the aircraft. The daisy chain assembly comprises a plurality of daisy chained loops thereby forming a plurality of daisy chained loop couplings. The release mechanism is weaved under each daisy chained loop coupling of the plurality of daisy chained loop couplings. The release pin is coupled to the daisy chain assembly. The pull handle is configured to, responsive to being pulled, release the release pin and pull the release mechanism so as to uncouple the plurality of daisy chained loop couplings.

### FIELD

The present disclosure generally relates to aircraft evacuation slides/rafts, and more specifically, to a daisy chain release mechanism for an evacuation slide/raft.

### BACKGROUND

In the event of an emergency landing, aircraft typically have one or more evacuation assemblies, such as inflatable evacuation slides, that may be deployed to facilitate safe evacuation of passengers and crew. If the emergency landing is a water landing, evacuation slides may be used as life rafts to hold evacuated passengers. When an evacuation slide is used to as a raft in such an event, the evacuation slide detaches from the aircraft. Typically, daisy chained loops are utilized to attach the evacuation slide/raft to the aircraft. However, in some instances, the daisy chained loops of the daisy chain assembly may be stiff from stowing such that the daisy chained loops stick together and fail to immediately release automatically from one another without manual intervention.

### SUMMARY

An emergency evacuation slide/raft for an aircraft is disclosed herein. The emergency evacuation slide/raft includes a girt, a daisy chain assembly, a release mechanism, a release pin, and a pull handle. The daisy chain assembly is configured to couple the girt to a girt sleeve affixed to the aircraft. The daisy chain assembly includes a plurality of daisy chained loops thereby forming a plurality of daisy chained loop couplings. The release mechanism is weaved under each daisy chained loop coupling of the plurality of daisy chained loop couplings. The release pin is coupled to the daisy chain assembly. The pull handle is configured to, responsive to being pulled, release the release pin and pull the release mechanism so as to uncouple the plurality of daisy chained loop couplings.

In various embodiments, the daisy chain assembly includes two daisy chain assemblies starting from a center of the girt outward in two opposite directions to edges of the girt. In various embodiments, the release mechanism is two release mechanisms each one associated with one of the two daisy chain assemblies.

In various embodiments, each of the two release mechanisms are coupled to the release pin. In various embodiments, responsive to the pull handle being pulled, the pull handle is configured to release the release pin and pull both of the two release mechanisms so as to uncouple the plurality of daisy chained loop couplings of the two daisy chain assemblies.

In various embodiments, the daisy chain assembly starts from one edge of the girt and releases toward the other end of the girt.

In various embodiments, a first end of the release mechanism is permanently coupled to at least one of the release pin or the pull handle.

In various embodiments, a second end of the release mechanism is temporarily coupled to at least one of an outer edge of the girt via an attachment mechanism, a last loop of the plurality of daisy chain loops, or substantially a last loop of the plurality of daisy change loops.

In various embodiments, the attachment mechanism is at least one of a hook and loop mechanism or a safety tie. In various embodiments, the release mechanism is at least one of a strap, webbing, string, or cord.

Also disclosed herein is an aircraft. The aircraft includes an emergency evacuation slide/raft. The emergency evacuation slide/raft includes a girt, a daisy chain assembly, a release mechanism, a release pin, and a pull handle. The daisy chain assembly is configured to couple the girt to a girt sleeve affixed to the aircraft. The daisy chain assembly includes a plurality of daisy chained loops thereby forming a plurality of daisy chained loop couplings. The release mechanism is weaved under each daisy chained loop coupling of the plurality of daisy chained loop couplings. The release pin is coupled to the daisy chain assembly. The pull handle is configured to, responsive to being pulled, release the release pin and pull the release mechanism so as to uncouple the plurality of daisy chained loop couplings.

In various embodiments, the daisy chain assembly includes two daisy chain assemblies starting from a center of the girt outward in two opposite directions to edges of the girt. In various embodiments, the release mechanism is two release mechanisms each one associated with one of the two daisy chain assemblies.

In various embodiments, each of the two release mechanisms are coupled to the release pin. In various embodiments, responsive to the pull handle being pulled, the pull handle is configured to release the release pin and pull both of the two release mechanisms so as to uncouple the plurality of daisy chained loop couplings of the two daisy chain assemblies.

In various embodiments, the daisy chain assembly starts from one edge of the girt and releases toward the other end of the girt.

In various embodiments, a first end of the release mechanism is permanently coupled to at least one of the release pin or the pull handle.

In various embodiments, a second end of the release mechanism is temporarily coupled to at least one of an outer edge of the girt via an attachment mechanism, a last loop of the plurality of daisy chain loops, or substantially a last loop of the plurality of daisy change loops.

In various embodiments, the attachment mechanism is at least one of a hook and loop mechanism or a safety tie. In various embodiments, the release mechanism is at least one of a strap, webbing, string, or cord.

Also disclosed herein is a method of releasing an emergency evacuation slide/raft from an aircraft. The method includes pulling a pull handle associated with the emergency evacuation slide/raft. Pulling the pull handle releases a release pin retaining a daisy chain assembly coupling a girt of the emergency evacuation slide/raft to a girt sleeve affixed to the aircraft. Also, pulling the pull handle pulls a release mechanism so as to uncouple a plurality of daisy chained loop couplings of the daisy chain assembly.

In various embodiments, the daisy chain assembly includes two daisy chain assemblies starting from a center of the girt outward in two opposite directions to edges of the girt. In various embodiments, the release mechanism is two release mechanisms each one associated with one of the two daisy chain assemblies.

In various embodiments, each of the two release mechanisms are coupled to the release pin. In various embodiments, responsive to the pull handle being pulled, the pull handle is configured to release the release pin and pull both of the two release mechanisms so as to uncouple the plurality of daisy chained loop couplings of the two daisy chain assemblies.

In various embodiments, the daisy chain assembly starts from one edge of the girt and releases toward the other end of the girt.

In various embodiments, a first end of the release mechanism is permanently coupled to at least one of the release pin or the pull handle.

In various embodiments, a second end of the release mechanism is temporarily coupled to at least one of an outer edge of the girt via an attachment mechanism, a last loop of the plurality of daisy chain loops, or substantially a last loop of the plurality of daisy change loops. In various embodiments, the attachment mechanism is at least one of a hook and loop mechanism or a safety tie. In various embodiments, the release mechanism is at least one of a strap, webbing, string, or cord.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a perspective view of an aircraft having an evacuation assembly, in accordance with various embodiments.

FIG. 2A is a perspective view of an upper ply and a lower ply of a mounting feature of an evacuation slide coupled to a girt sleeve of an aircraft, in accordance with various embodiments.

FIG. 2B is a perspective view of an upper ply and a lower ply of a mounting feature of an evacuation slide uncoupled from a girt sleeve of an aircraft, in accordance with various embodiments.

FIG. 3 illustrates a typical attachment of an evacuation slide/raft coupled to an aircraft, in accordance with various embodiments.

FIGS. 4A, 4B, and 4C illustrate a daisy chain release mechanism that releases daisy chained loops of a daisy assembly as the release pin is removed, in accordance with various embodiments.

FIG. 5 illustrates a released daisy chained loops of a daisy assembly after being removed by a daisy chain release mechanism, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As previously stated, if the emergency landing of an aircraft is a water landing, emergency evacuation slides/rafts may be used as life rafts to hold evacuated passengers. When an emergency evacuation slide/raft is used to as a raft in such an event, the emergency evacuation slide/raft detaches from the aircraft. Typically, daisy chained loops are utilized to attach the emergency evacuation slide/raft to the aircraft. However, in some instances, the daisy chained loops of the daisy chain assembly may be stiff from stowing such that the daisy chained loops stick together and fail to immediately release automatically from one another without manual intervention.

Disclosed herein is a system, in various embodiments, where a daisy chain release mechanism automatically releases daisy chained loops of a daisy chain assembly as a release pin is removed. In various embodiments, a set of release mechanisms such as a straps, webbings, strings, or cords, among others, are coupled to a release pin. In various embodiment, the release mechanisms are then weaved back and forth under the daisy chained loop couplings of the daisy chain assembly from the release pin outward in two opposite directions to the ends of the girt sleeve. In various embodiments, ends of the release mechanisms are temporarily coupled to outer edges of the girt sleeve. In various embodiments, the ends of the release mechanisms may be temporarily coupled to the outer edges of the girt sleeve via an attachment mechanism, such as a hook and loop mechanism or a safety tie, among others. In various embodiments, the ends of the release mechanisms may be temporarily coupled to a last loop of the daisy chain loop. In various embodiments, the ends of the release mechanisms may be temporarily coupled to substantially a last loop of the daisy chain loop. In various embodiments, responsive to the release pin being pulled via a pull handle, the release pin is released, and the release mechanisms are pulled outward from under the each of the daisy chained loops, thereby uncoupling each instant daisy chained loop from a following daisy chained loop. In various embodiments, once all the daisy chained loops are uncoupled, the attachment mechanism uncouples from its temporary coupling.

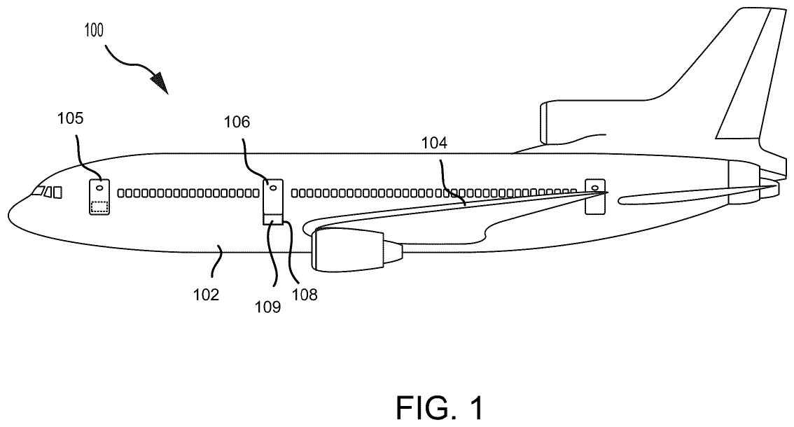

Referring now to FIG. 1, in accordance with various embodiments, an aircraft 100 is illustrated, in accordance with various embodiments. Aircraft 100 may comprise a fuselage 102 with wings 104 fixed to fuselage 102. An evacuation assembly, such as an emergency evacuation slide/raft, may be deployable from the aircraft. In various embodiments, the emergency evacuation slide/raft may be mounted on an interior of aircraft entry/exit door 105 and attached to a door sill or floor of the aircraft entry/exit door 105. In various embodiments, the emergency evacuation slide/raft may be positioned below an emergency exit door 106. In various embodiment, the emergency evacuation slide/raft may be positioned in a belly faring to which where the wings 104 are coupled to the fuselage 102. In instances where the emergency evacuation slide/raft are positioned below an emergency exit door 106 or in the belly faring, a blowout panel 109 may cover evacuation assembly in a pre-deployed state on the aircraft 100. In various embodiments, the evacuation assembly may include and/or be housed within a packboard 108 mounted to the aircraft 100. The evacuation assembly may jettison the blowout panel 109 and deploy an emergency evacuation slide/raft, such as an inflatable emergency evacuation slide/raft, in response to emergency exit door 106 opening or in response to another evacuation event.

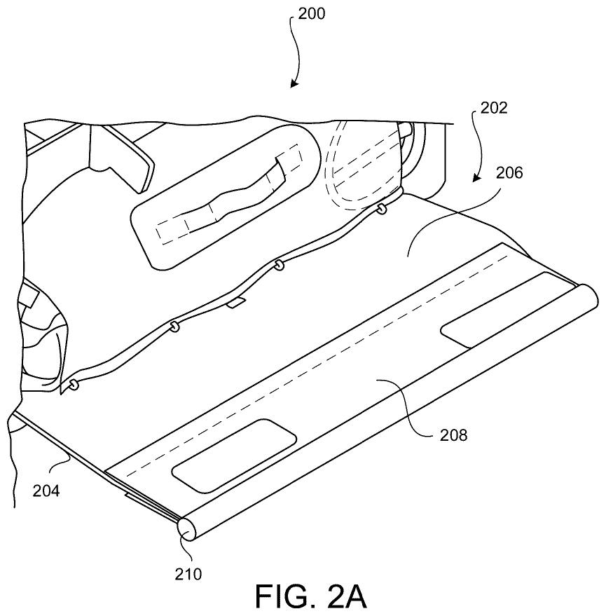

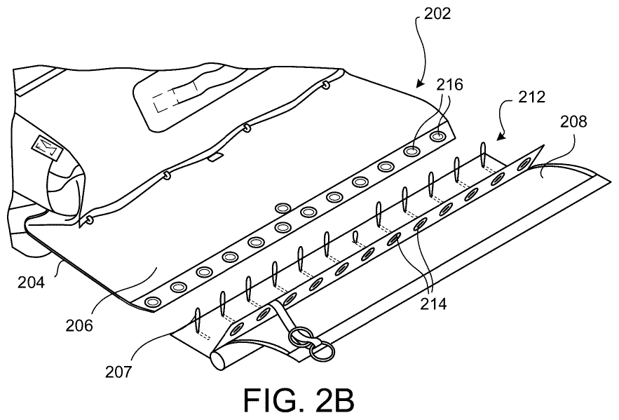

Referring now to FIGS. 2A and 2B, in accordance with various embodiments, a perspective view of an upper ply and a lower ply of a mounting feature of an emergency evacuation slide/raft 200 coupled to a girt sleeve of an aircraft, such as aircraft 100 of FIG. 1, and a perspective view of an upper ply and a lower ply of a mounting feature of the emergency evacuation slide/raft 200 uncoupled from a girt sleeve of an aircraft are illustrated, respectively. A girt 202 includes one or more plies 204, 206 of material that are coupled to a girt sleeve 208, which is affixed to a frame of the aircraft in slide mode. The girt sleeve 208 may include a support bar 210 (or may define a pocket into which a support bar may be inserted) that is configured to be affixed to the aircraft. The support bar 210 of the girt sleeve 208 may be configured to be the primary load bearing connection point between the aircraft and the emergency evacuation slide/raft 200 in slide mode. In cases when evacuation slide/raft 200 is installed in the fuselage or belly fairing, support bar 210 may not be required and girt sleeve 208 could be attached directly to the packboard or aircraft via fasteners or other method. Extending from the support bar 210 of the girt sleeve 208 may be one or more panels of material that are mated with the one or more plies of material of the girt 202. For example, the girt 202 may have an upper ply 204 and a lower ply 206. The plies 204, 206 may be coupled to the girt sleeve 208. For example, a daisy chain assembly 212 may be utilized to reversibly affix the girt 202 to the aircraft via the girt sleeve 208. The daisy chain assembly 212 may include a plurality of tethers or daisy chain loops 207 interlaced with grommets/holes 214, 216 on the plies 204, 206 of the girt 202 and the girt sleeve 208. Once each of the daisy chain loops 207 are fed through the grommets/holes 214, 216, starting from and outermost edge of the girt 202 and the girt sleeve 208, an outermost daisy chain loop 207 is placed around a next most outermost daisy chain loop 207 until reaching a center of the girt 202 and the girt sleeve 208 thereby forming two daisy chains. Once at the center of the girt 202 and the girt sleeve 208, the daisy chain assembly 212 may include a release pin that retains the innermost daisy chain loops 207 so that the daisy chain loops 207 do not become uncoupled. The daisy chain assembly 212 may also include a pull handle coupled to the release pin so that, in response to the pull handle being translated by a user (e.g., a passenger or crew member, among others), causes the release pin to be released and the lacing of the daisy chain to release, thereby enabling the evacuation slide/raft 200 to be detached from the aircraft and transitioned to the raft mode.

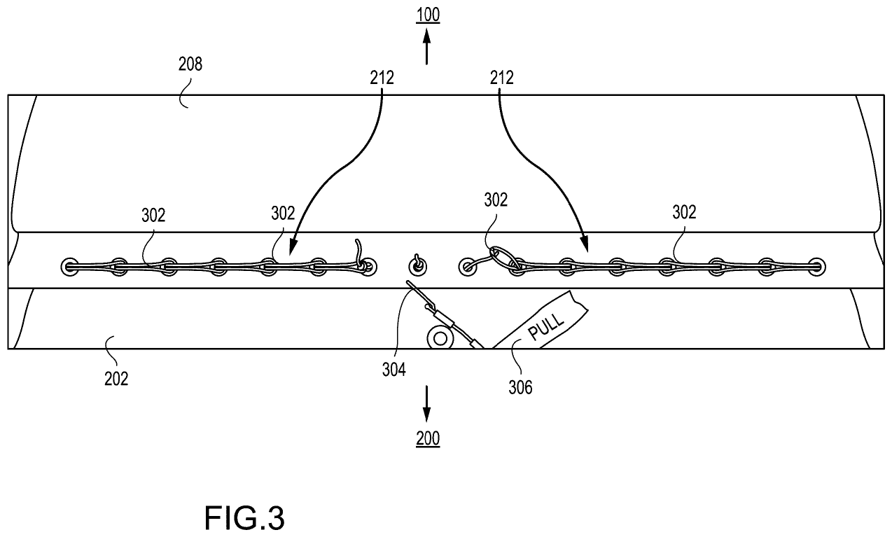

Referring now to FIG. 3, in accordance with various embodiments, a typical attachment of an emergency evacuation slide/raft coupled to an aircraft is illustrated. In various embodiments, daisy chained loops 302 of a daisy chain assembly 212 are utilized to attach the girt 202 of the emergency evacuation slide/raft 200 to the girt sleeve 208 the aircraft 100. Responsive to the release pin 304 being pulled via the pull handle 306, the daisy chain assembly 212 is released, allowing the emergency evacuation slide/raft 200 to separate from the aircraft 100. However, in some instances, the daisy chained loops 302 of the daisy chain assembly 212 may be stiff from stowing such that they stick together, i.e. the daisy chained loops 302 do not immediately automatically release from one another, as illustrated, without manual intervention.

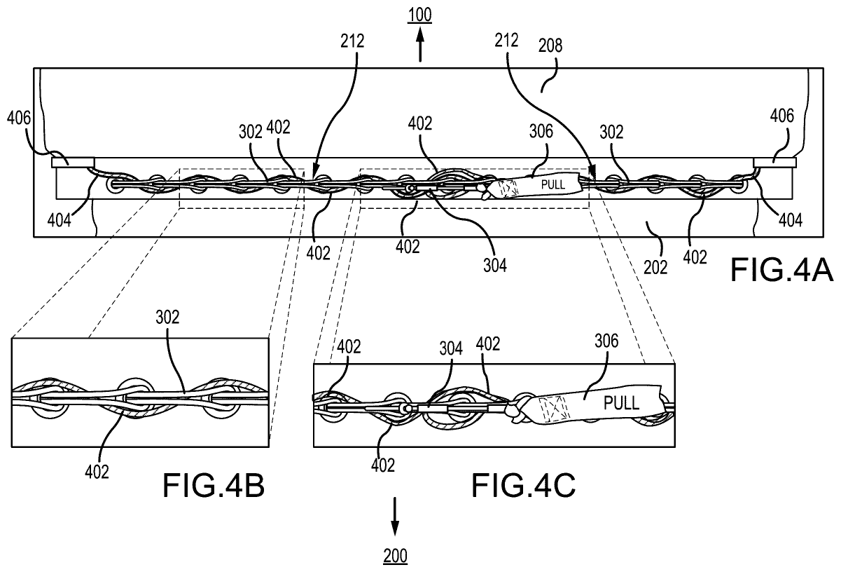

Referring now to FIGS. 4A, 4B, and 4C, in accordance with various embodiments, a daisy chain release mechanism that releases daisy chained loops of a daisy assembly as the release pin is removed is illustrated. In various embodiments, daisy chained loops 302 of a daisy chain assembly 212 are utilized to attach the girt 202 of the emergency evacuation slide/raft 200 to the girt sleeve 208 the aircraft 100. In various embodiments, a set of release mechanisms 402 such as a straps, webbings, strings, or cords, among others, have a first end permanently coupled to the release pin 304 and/or the pull handle 306. In various embodiments, the point where the set of release mechanisms 402 are coupled to the release pin 304 and/or the pull handle 306 may include in order that the release pin 304 may pull out of the daisy chained loops 302. In various embodiment, the release mechanisms 402 are weaved back and forth under the daisy chained loops 302 of the daisy chain assembly 212 from the release pin 304 (i.e. center of the girt 202 and the girt sleeve 208) outward in two opposite directions to the edges of the girt 202. In various embodiment, the release mechanisms 402 are weaved back and forth under the daisy chained loops 302 of the daisy chain assembly 212 from the release pin 304 (i.e. on one end of the girt 202 and the girt sleeve 208) toward another end of the girt 202 and the girt sleeve 208. In various embodiments, second ends 404 of the release mechanisms 402 are temporarily coupled to outer edges of the girt sleeve 208. In various embodiments, the ends 404 of the release mechanisms 402 may be temporarily coupled to the outer edges of the girt sleeve 208 via attachment mechanisms 406, such as a hook and loop mechanism or a safety tie, among others. In various embodiments, the ends 404 of the release mechanisms 402 may be temporarily coupled to a last loop of the daisy chain loop. In various embodiments, the ends 404 of the release mechanisms 402 may be temporarily coupled to substantially a last loop of the daisy chain loop. In various embodiments, responsive to the release pin 304 being pulled via a pull handle 306, the release pin 304 is released and the release mechanisms 402 are pulled outward from under the each of the daisy chained loops 302, thereby uncoupling each instant daisy chained loop from a following daisy chained loop. In various embodiments, once all the daisy chained loops 302 are uncoupled, the attachment mechanisms 406 uncouple from their temporary coupling.

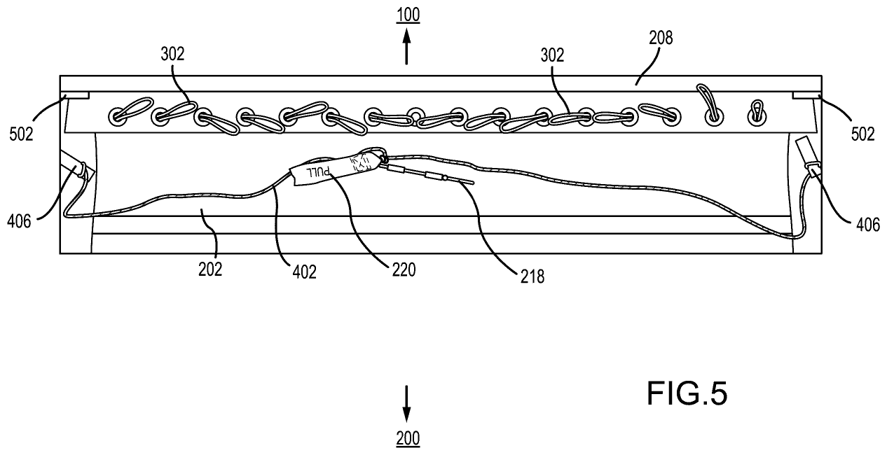

Referring now to FIG. 5, in accordance with various embodiments, released daisy chained loops of a daisy assembly after being removed by a daisy chain release mechanism is illustrated. In various embodiments, responsive to the release pin 304 being pulled via a pull handle 306, the release pin 304 is released and the release mechanisms 402 are pulled outward from under the each of the daisy chained loops 302, thereby uncoupling each instant daisy chained loop from a following daisy chained loop. In various embodiments, once all the daisy chained loops 302 are uncoupled, the attachment mechanisms 406 uncouple from their temporary coupling points 502. In various embodiments, with all of the daisy chained loops 302 of a daisy chain assembly 212 uncoupled, the girt 202 of the emergency evacuation slide/raft 200 may be release from the to the girt sleeve 208 the aircraft 100.

Accordingly, in various embodiments, implementing a daisy chain release mechanism, as described previously, eases the release of the emergency evacuation slide/raft during an aircraft event. In that regard, in various embodiments, the daisy chain release mechanism negates any need for manual intervention in the manipulation of the daisy chained loops to release one daisy chained loop from another daisy chained loop. In various embodiments, implementing the daisy chain release mechanism, as described previously, may also reduce training of airline crew members on releasing the emergency evacuation slide/raft from the aircraft.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An emergency evacuation slide/raft for an aircraft, the emergency evacuation slide/raft comprising:
a girt;
a daisy chain assembly configured to couple the girt to a girt sleeve affixed to the aircraft, wherein the daisy chain assembly comprises a plurality of daisy chained loops thereby forming a plurality of daisy chained loop couplings;
a release mechanism weaved under each daisy chained loop coupling of the plurality of daisy chained loop couplings;
a release pin coupled to the daisy chain assembly; and
a pull handle configured to, responsive to being pulled, release the release pin and pull the release mechanism so as to uncouple the plurality of daisy chained loop couplings.

2. The emergency evacuation slide/raft of claim 1, wherein the daisy chain assembly comprises two daisy chain assemblies starting from a center of the girt outward in two opposite directions to edges of the girt and wherein the release mechanism is two release mechanisms each one associated with one of the two daisy chain assemblies.

3. The emergency evacuation slide/raft of claim 2, wherein each of the two release mechanisms are coupled to the release pin and wherein, responsive to the pull handle being pulled, the pull handle is configured to release the release pin and pull both of the two release mechanisms so as to uncouple the plurality of daisy chained loop couplings of the two daisy chain assemblies.

4. The emergency evacuation slide/raft of claim 1, wherein the daisy chain assembly starts from one edge of the girt and releases toward the other end of the girt.

5. The emergency evacuation slide/raft of claim 1, wherein a first end of the release mechanism is permanently coupled to at least one of the release pin or the pull handle.

6. The emergency evacuation slide/raft of claim 5, wherein a second end of the release mechanism is temporarily coupled to at least one of an outer edge of the girt via an attachment mechanism, a last loop of the plurality of daisy chain loops, or substantially a last loop of the plurality of daisy change loops.

7. The emergency evacuation slide/raft of claim 6, wherein the attachment mechanism is at least one of a hook and loop mechanism or a safety tie and wherein the release mechanism is at least one of a strap, webbing, string, or cord.

8. An aircraft, the aircraft comprising:
an emergency evacuation slide/raft, the emergency evacuation slide/raft comprising:
a girt;
a daisy chain assembly configured to couple the girt to a girt sleeve affixed to the aircraft, wherein the daisy chain assembly comprises a plurality of daisy chained loops thereby forming a plurality of daisy chained loop couplings;
a release mechanism weaved under each daisy chained loop coupling of the plurality of daisy chained loop couplings;
a release pin coupled to the daisy chain assembly; and
a pull handle configured to, responsive to being pulled, release the release pin and pull the release mechanism so as to uncouple the plurality of daisy chained loop couplings.

9. The aircraft of claim 8, wherein the daisy chain assembly comprises two daisy chain assemblies starting from a center of the girt outward in two opposite directions to edges of the girt and wherein the release mechanism is two release mechanisms each one associated with one of the two daisy chain assemblies.

10. The aircraft of claim 9, wherein each of the two release mechanisms are coupled to the release pin and wherein, responsive to the pull handle being pulled, the pull handle is configured to release the release pin and pull both of the two release mechanisms so as to uncouple the plurality of daisy chained loop couplings of the two daisy chain assemblies.

11. The aircraft of claim 8, wherein the daisy chain assembly starts from one edge of the girt and releases toward the other end of the girt.

12. The aircraft of claim 8, wherein a first end of the release mechanism is permanently coupled to at least one of the release pin or the pull handle.

13. The aircraft of claim 12, wherein a second end of the release mechanism is temporarily coupled to at least one of an outer edge of the girt via an attachment mechanism, a last loop of the plurality of daisy chain loops, or substantially a last loop of the plurality of daisy change loops.

14. The aircraft of claim 13, wherein the attachment mechanism is at least one of a hook and loop mechanism or a safety tie and wherein the release mechanism is at least one of a strap, webbing, string, or cord.

15. A method of releasing an emergency evacuation slide/raft from an aircraft, the method comprising:
pulling a pull handle associated with the emergency evacuation slide/raft, wherein:
pulling the pull handle releases a release pin retaining a daisy chain assembly coupling a girt of the emergency evacuation slide/raft to a girt sleeve affixed to the aircraft; and
pulling the pull handle pulls a release mechanism so as to uncouple a plurality of daisy chained loop couplings of the daisy chain assembly.

16. The method of claim 15, wherein the daisy chain assembly comprises two daisy chain assemblies starting from a center of the girt outward in two opposite directions to edges of the girt and wherein the release mechanism is two release mechanisms each one associated with one of the two daisy chain assemblies.

17. The method of claim 16, wherein each of the two release mechanisms are coupled to the release pin and wherein, responsive to the pull handle being pulled, the pull handle is configured to release the release pin and pull both of the two release mechanisms so as to uncouple the plurality of daisy chained loop couplings of the two daisy chain assemblies.

18. The method of claim 15, wherein the daisy chain assembly starts from one edge of the girt and releases toward the other end of the girt.

19. The method of claim 15, wherein a first end of the release mechanism is permanently coupled to at least one of the release pin or the pull handle.

20. The method of claim 19, wherein a second end of the release mechanism is temporarily coupled to at least one of an outer edge of the girt via an attachment mechanism, a last loop of the plurality of daisy chain loops, or substantially a last loop of the plurality of daisy change loops, wherein the attachment mechanism is at least one of a hook and loop mechanism or a safety tie, and wherein the release mechanism is at least one of a strap, webbing, string, or cord.
